(19) United States
(12) Patent Application Publication
(10) Pub. No.: US 2007/0278865 A1
(43) Pub. Date: Dec. 6, 2007

(54) Electric Machine

(75) Inventor: Gerhard Matscheko, Starnberg (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, 80333 Munchen (DE)

(21) Appl. No.: 11/574,944

(22) PCT Filed: Sep. 8, 2005
(86) PCT No.: PCT/EP05/54449

§ 371 Date: Mar. 8, 2007

(30) Foreign Application Priority Data
Sep. 16, 2004 (DE) 10 2004 044 985.6

(51) Int. Cl. H02K 41/02; H02K 1/06

(52) U.S. Cl. 310/12; 310/10

(57) ABSTRACT

The invention relates to an electric motor (1-8), comprising a primary piece (21,22,52-57) and a secondary piece (15,16,17), whereby the primary piece (21,22,52-57) has a side (82) facing the secondary piece and the secondary piece (15,16,17) has a side (83), facing the primary piece (21,22,52-57), whereby said facing sides (82,83) are provided for the efflux and/or influx of magnetic fields. The primary piece (21,22,52-57) at least partly contacts the secondary piece (15,16,17) in a contact region (88), whereby the contact region (88) relates to at least one of the facing sides (82,83), provided for efflux and/or influx of magnetic fields. An air gap which is conventionally located between the primary piece (21,22,52-57) and the secondary piece (15,16,17) is at least partly replaced by a contact region between the primary piece (21,22,52-57) and the secondary piece (15,16,17).

The invention relates to an electric machine or a primary part and/or a secondary part of an electric machine.

The electric machine has a primary part and a secondary part. The primary part and the secondary part are positioned in relation to one another in accordance with the prior art such that an air gap is formed between the primary part and the secondary part. The electric machine is, for example, a linear motor, the primary part having windings, and the secondary part having permanent magnets. In order to form the air gap, guidance of the primary part and/or of the secondary part is required. With the aid of such guidance, which is used as a spacer, the primary part is spaced apart from the secondary part. This is possible in the case of rotary electric machines, for example, by mounting of the rotor, which represents the secondary part. In this case, both in the case of rotary electric machines and in the case of linear motors, which are also electric machines, stringent requirements are placed on the guidance with respect to manufacturing tolerances, since the air gap needs to be kept constant over the entire range of movement of the secondary part in relation to the primary part. This is necessary in order that the electric machine always has the same properties, in particular with respect to the development of an electromagnetic force EMF, irrespective of the position of the secondary part in relation to the primary part. Ensuring an air gap having a constant size is complex. This is particularly relevant in the case of linear motors, which may also have long displacement paths. Since the air gap is very small, it is necessary for measures to be taken to ensure that no disruptive foreign bodies enter the air gap between the primary part and the secondary part. A foreign body is particularly disruptive when it has a size which approximately corresponds to the size of the air gap or exceeds its size. Owing to design measures, such as owing to covers or else owing to sweeping devices, for example, a situation can be achieved in which no foreign bodies enter the air gap. The problem of foreign bodies in the air gap occurs in particular in the case of linear motors, since, in the case of these linear motors, the air gap is in an exposed position, such as, by way of comparison, in the case of a rotary electric machine which has a stator and a rotor.

The object of the present invention is now to overcome the abovementioned disadvantages, i.e. ensuring a constant distance between the primary part and the secondary part in a simple manner and/or also reducing contamination of the area between the primary part and the secondary part, i.e. of the air gap.

This object is achieved by means of an electric machine having the features as claimed in claim 1 or in the case of an electric machine having the features as claimed in claim 3. The object is achieved further by a primary part as claimed in claim 9 and a secondary part as claimed in claim 11. Dependent claims 2, 4 to 8, 10 and 12 represent inventive developments of the respective apparatus.

In an electric machine which has a primary part and a secondary part, the primary part having a side facing the secondary part, and the secondary part having a side facing the primary part, these sides being provided for the emergence and/or entry of magnetic fields, the primary part bears at least partially against the secondary part in a contact region. The contact region relates to at least one of the mutually facing sides of the primary part and the secondary part of the electric machine, at least one of these sides being provided for the emergence and/or entry of magnetic fields.

The sides of the primary part or the secondary part which are provided for the emergence and/or entry of magnetic fields are magnetically active sides.

An electric machine according to the invention can therefore be designed such that the primary part at least partially touches the magnetically active side of the secondary part, the secondary part having, for example, permanent magnets, which are always magnetically active.

The electric machine can be designed such that the primary part has windings and the secondary part has permanent magnets. Magnetic fields can be produced or are produced both owing to the windings and owing to the permanent magnets. These magnetic fields emerge from and/or enter the primary part and/or the secondary part and are closed in each case via the opposite part.

With respect to the primary part, touching contact is made with the secondary part, for example at least partially in a region which has windings through which current can flow.

Owing to the touching contact between the primary part and the secondary part in a contact region, which is provided for the entry or emergence of magnetic fields so as to obtain an electromagnetic force EMF, a simple possibility results for implementing a constant spacing between the primary part and the secondary part.

In an advantageous configuration of the electric machine, the side of the primary part which faces the secondary part has a slide-promoting surface.

In a further advantageous configuration of the electric machine, the side of the secondary part which faces the primary part has a slide-promoting surface.

The slide-promoting surfaces are used for reducing the friction and for increasing the efficiency of the electric machine.

The object is achieved further in the case of an electric machine which has a primary part and a secondary part, an air gap being formed between the primary part and the secondary part, the air gap being entirely or partially replaced by a sliding layer. The air gap is the region between the secondary part and the primary part of the electric machine, which contributes to the formation of an electromagnetic force EMF. Magnetic fields, which emerge from the secondary part or the primary part and enter the other, opposite part, run in the air gap. The sliding layer advantageously has a similar value JR to the air gap. In a configuration of the sliding layer, the sliding layer is in the form of a foil (sliding foil). This has the advantage that, in event of damage, foils can be replaced easily by a new foil. In a further configuration, the sliding layer is a coating on one side. A possible coating material is, for example, Teflon. The sliding layer should have such a material which has a good sliding property and in particular is also pressure-resistant and subject to little wear.

In one further configuration of the electric machine, the slide-promoting surface is realized with the aid of a sliding layer. The sliding layer is located on the primary part and/or on the secondary part.

In a further advantageous configuration, the sliding layer, such as a sliding foil, for example, is replaceable, with the result that the sliding layer can easily be replaced by a new sliding layer in the event of contamination or in the event of a defect.

In a further advantageous configuration of the electric machine, the electric machine is a linear motor, the linear motor in particular having a first primary part and a secondary primary part. A secondary part is associated with the first primary part and the second primary part. This results, for example, in an arrangement of a double-comb linear motor.

In a further configuration of the electric machine, this electric machine is in the form of a linear motor, the linear motor having at least three primary parts, which are associated with a secondary part. The primary parts are advantageously grouped around the secondary part such that self-mounting of the primary part with respect to the secondary part results. The self-mounting results owing to the attraction of the primary parts to the secondary part, which has permanent magnets.

By means of targeted utilization of a magnetic force of attraction of the primary parts to the secondary part on one side, which force can be adjusted in a defined manner, it is possible to adjust a sliding behavior of the primary part or the primary parts with respect to the secondary part in a suitable manner. The adjustment takes place, for example, by selecting different thicknesses for the sliding layer. If a sliding layer between a first primary part and the secondary part is thinner than a sliding layer between a secondary primary part and the secondary part, the magnetic force of attraction between the first primary part and the secondary part is greater than between the second primary part and the same secondary part. This results in predetermined positioning of the primary parts with respect to the secondary part, as there are different forces of attraction.

In one advantageous configuration of the electric machine, the secondary part is arranged eccentrically between the primary parts. The eccentric arrangement of the primary parts with respect to the secondary part takes place as described above, for example, owing to different thicknesses of the sliding layers. In this case, the sliding layers are fitted to the primary parts and/or to the secondary part in the contact region between the primary part and the secondary part. By means of the eccentric arrangement, it is possible to adjust and maintain asymmetrical distances between the primary part and a secondary part.

The lower the force of attraction between the primary part and the secondary part is, the less the sliding layer is subjected to a load. A reduction in the load on the sliding layer is also possible owing to the fact that the surface of the sliding layer between the primary part and the secondary part is selected to be as large as possible. Advantageously, materials are used as the sliding layer which are cost-effective and durable. If a sliding layer is not designed for the entire life of the electric machine, it is necessary to take care that the sliding layer is, for example, a sliding element or a sliding foil, which can be replaced easily. This easy replaceability is particularly advantageous in the case of self-mounted linear motors, since these are installed in a very compact manner.

The self-mounting of the linear motor results from the various magnetic forces of attraction between the at least two primary parts and the one secondary part of the linear motor.

Exemplary embodiments of the apparatuses according to the invention which relate to the electric machine or the primary part or the secondary part will be explained in more detail with reference to the attached drawings, in which:

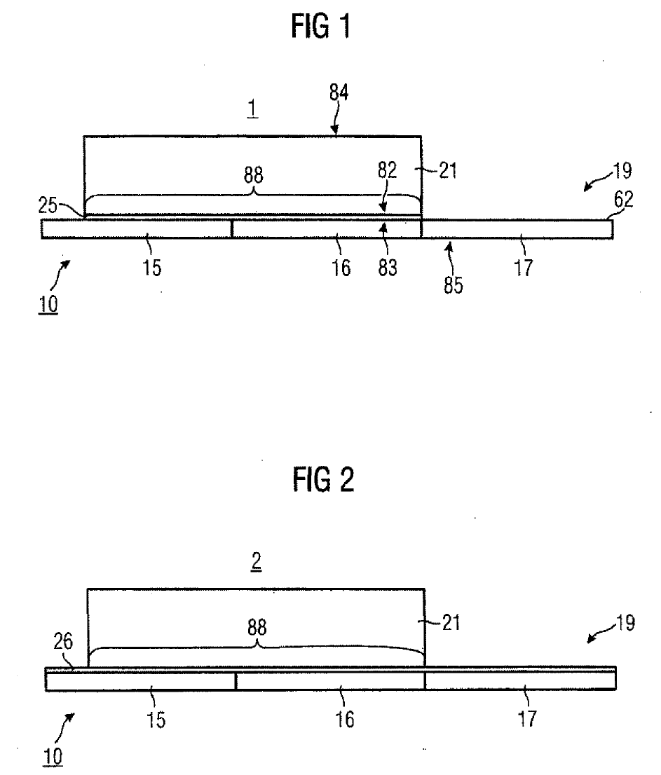

FIG. 1 shows a linear motor having a sliding layer on a primary part,

FIG. 2 shows a linear motor having a sliding layer on a secondary part,

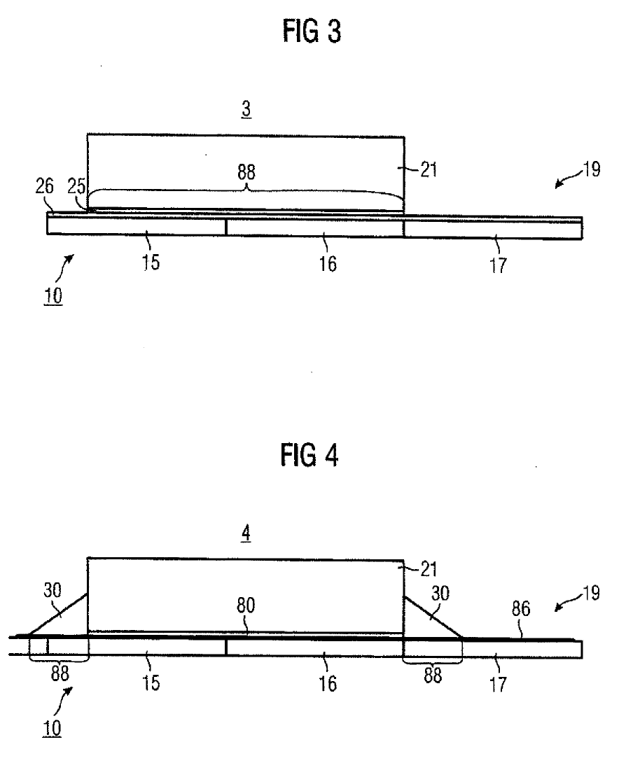

FIG. 3 shows a linear motor having sliding layers both on the primary part and on the secondary part,

FIG. 4 shows a linear motor with skids,

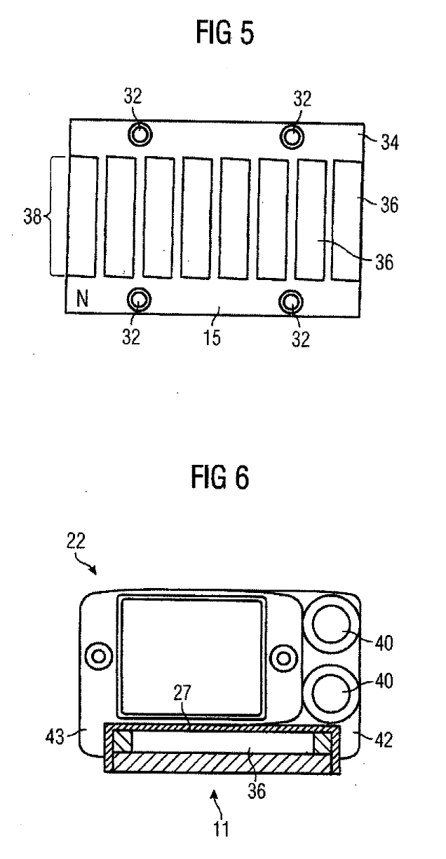

FIG. 5 shows a primary part of a linear motor,

FIG. 6 shows a further configuration of a linear motor,

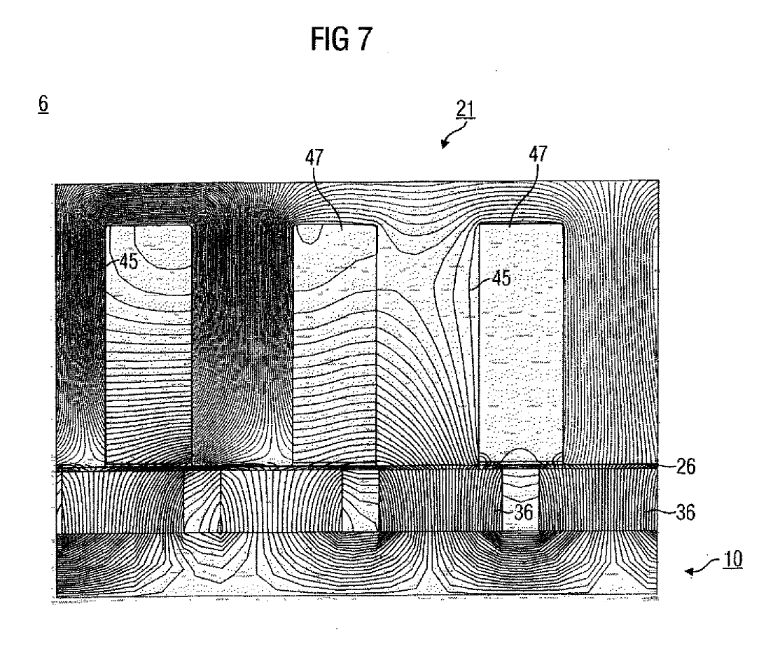

FIG. 7 shows a field profile between the primary part and the secondary part,

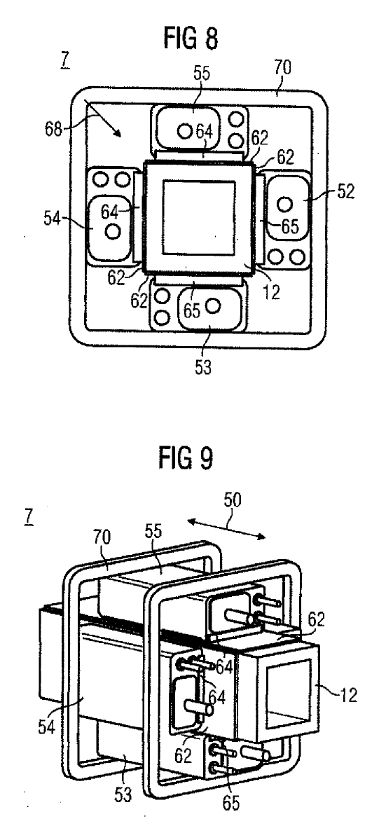

FIG. 8 shows a self-mounted linear motor with four primary parts,

FIG. 9 shows a perspective illustration of the linear motor shown in FIG. 8,

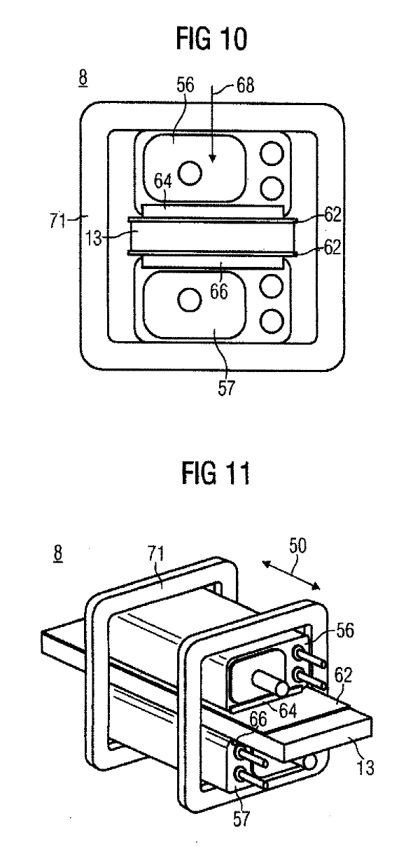

FIG. 10 shows a linear motor with two primary parts, and

FIG. 11 shows the linear motor shown in FIG. 10 in a perspective illustration.

The illustration in FIG. 1 shows a linear motor 1. The linear motor 1 is an electric machine 1. The linear motor 1 has a primary part 21 and a secondary part 10. The secondary part 10 has various secondary part elements 15,16,17. At least the secondary part elements 15,16,17 are provided with a running path for the primary part 21. The primary part 21 has a side 82 facing the secondary part and a side 84 facing away from the secondary part. The secondary part, for its part, has a side 83 facing the primary part and a side 85 facing away from the primary part 21. The primary part 21 has a sliding layer 25. The sliding layer 25 is, for example, a sliding foil. The sliding layer 25 is arranged between the primary part 21 and the secondary part 10 such that, owing to the sliding layer 25, the air gap which, in accordance with the prior art, is formed between the primary part and the secondary part is at least partially or even completely replaced by the sliding layer 25. A sliding region 88 is formed by means of the sliding layer 25. The sliding region extends, as does the sliding layer 25, not only in a longitudinal direction (movement direction) which is predetermined by the secondary part 10, but also over a width of the primary part 2. The width of the primary part, however, is not shown in the illustration in FIG. 1.

The illustration in FIG. 2 shows a linear motor 2, which, in contrast to the linear motor 1, has a secondary part 10, which has the sliding layer 26. The primary part 21 shown in FIG. 2 does not have a sliding layer. The sliding layer 26 on the secondary part 10 is also in the form of a sliding foil, for example.

The illustration in FIG. 3 shows a linear motor 3, which has a primary part 21 and a secondary part 10, both the primary part 21 and the secondary part having sliding layers 25, 26. The primary part 21 therefore has a sliding layer 25, and the secondary part 10 has a sliding layer 26, these sliding layers 25, 26 sliding on one another.

The illustration in FIG. 4 shows a linear motor 4, which has a primary part 21 to which skids 30 are fitted. The skids 30 are located in a region of the secondary part, which is provided for the emergence and/or entry of magnetic fields. The secondary part 10 therefore has, for example, permanent magnets, which are not illustrated in FIG. 4, and, in this region of the permanent magnets, the skids 30 are positioned such that they slide over the permanent magnets. A cover 86 may also be located between the skid 30 and the permanent magnet. The cover 86 is in particular provided for the purpose of covering points of impact between the secondary part elements 15,16 and 17. Advantageously, the cover 86 consists of a soft-magnetic material, with the result that the cover 86 is attracted by the permanent magnet (not illustrated in FIG. 4) of the secondary part. The skids 30 therefore slide on the cover 86 beyond the permanent magnets.

The illustration in FIG. 5 shows a secondary part element 15. The secondary part element has drilled holes 32 for fixing this element. Furthermore, the secondary part element 15 has permanent magnets 36. The permanent magnets 36 are arranged in a sliding region 38. The sliding region 38 is therefore the region in which a sliding layer is positioned. The sliding layer, as can be seen in FIG. 5, is located in a region of the secondary part which is provided for the emergence and/or entry of magnetic fields. The sliding region 38 is also the contact region between the primary part and the secondary part, depending on the position of a primary part (not illustrated).

The illustration in FIG. 6 shows a linear motor, which has a primary part 22 and a secondary part 11. The primary part 22 has electrical connections 40 for windings of the primary part 22, the windings not being illustrated in FIG. 6. Furthermore, the primary part has projections 42 and 43. The projections engage over a secondary part 11. The secondary part 11 has, in addition to permanent magnets 36, a sliding layer 27. The sliding layer 27 is in this case located not only in the magnetically active region between the primary part and the secondary part, but also in a side region of the secondary part, which adjoins the projections 42 and 43. Owing to the arrangement in FIG. 6, targeted guidance of the primary part 22 on the secondary part 11 is possible.

The illustration in FIG. 7 shows field profiles 45 between a primary part 21 and a secondary part 10. The primary part 10 has a sliding layer 26, the primary part 23 resting directly on the sliding layer 26 of the secondary part 10. The illustration in FIG. 7 also shows slots 47, which are used for accommodating windings, which are not illustrated.

The illustration in FIG. 8 shows an electric machine, which is a linear motor 7 which has four primary parts 52, 53, 54 and 55. The primary parts 52, 53, 54 and 55 are fixed to a square frame 70. The primary parts 52-55 are positioned such that they are aligned with respect to a common secondary part 12. The primary parts have sliding layers 64 and 66. These sliding layers 64 and 66 have a different thickness, however. The sliding layer 64, which is fitted to the primary parts 54 and 55, is a thinner sliding layer than the sliding layer 66, which is fitted to the primary parts 56 and 53. Owing to the use of the thinner sliding layer 64, a higher force of attraction of the secondary part 12 to the primary parts 54 and 55 results. This higher force of attraction is indicated by an arrow 68, which represents the resultant force of attraction.

This design of the linear motor 7 results in a self-mounted linear motor having an encompassing embodiment. The encompassing embodiment results from the fact that the four primary parts 52 to 55 encompass the secondary part 12. The self-mounting results, in turn, from the fact that, owing to the different sliding layers, different forces of attraction are effective between the primary part 52 to 55 and the secondary part 12 and, accordingly, the secondary part 12 assumes a preferred position with respect to two primary parts, namely the primary parts 54 and 55. Since the secondary part 12 has covers 62, the primary parts 52 to 55 slide on the covers of the secondary part 12.

The illustration in FIG. 9 shows the linear motor in FIG. 7 in a perspective illustration, in particular in this case the possible movement directions of the secondary part 12 or of the primary parts 52 to 55 being illustrated by a double arrow 50. With respect to the movement direction 50, note should therefore be made of the fact that the linear motor in FIGS. 8 and 9 can be designed such that either the primary parts move with respect to the secondary part, the secondary part 12 being stationary, or the secondary part 12 moves in relation to the primary parts 52 to 55, the primary parts 52 to 55 being stationary.

FIG. 10 shows a linear motor 8, which has two primary parts 56 and 57. The primary parts 56 and 57 are fixed to a frame 73. A secondary part 13 is located between the primary parts 56 and 57. The secondary part 13 has a magnet cover 62. The magnet cover is located both on the side facing the primary part 56 and on the side facing the primary part 57 of the secondary part 13. The primary part 56 has a thin sliding layer 64. The primary part 57 has a thicker sliding layer 66. Owing to the different thicknesses of the sliding layers 64 and 66, a force of attraction 86 of the secondary part 13 with respect to the primary part 56 results. As in the case of a linear motor shown in FIGS. 8 and 9, this in turn results in self-mounting of the linear motor, in FIG. 10 the linear motor being a double-comb linear motor.

The illustration in FIG. 11 shows the linear motor 8 in FIG. 10 in a perspective illustration. In the perspective illustration it can be seen particularly clearly that the primary part 56 or 57 slides on the secondary part 13, the sliding layers 64 and 66 lying on the magnet cover 62 of the secondary part 13. With respect to the movement direction 50, note should in turn be made of the fact that either the primary part is moveable, in which case the secondary part is stationary, or the primary parts 56 and 57 are stationary in their frame 73 and the secondary part 13 is capable of implementing the movement directions 50.

1-12. (canceled)

13. An electrical machine, comprising:
a primary having at least two primary parts; and
a secondary part arranged eccentrically in relation to the primary, thereby defining an air gap between the primary and the secondary part, wherein at least one of the primary and the secondary part has a sliding layer extending in the air gap to at least partially fill the air gap.

14. The electrical machine of claim 13, constructed in the form of a linear motor.

15. The electrical machine of claim 13, wherein the sliding layer entirely fills the air gap.

16. The electrical machine of claim 14, wherein the primary has at least three primary parts placed around the secondary part so that the linear motor is a self-contained structure.

17. The electrical machine of claim 13, wherein the secondary part is arranged eccentrically between the two primary parts to thereby define an air gap between one of the primary parts and the secondary part, and another air gap between the other one of the primary parts and the secondary part, so that each of the air gaps is at least partly filled with a sliding layer.

18. The electrical machine of claim 17, wherein the sliding layer in one air gap and the sliding layer in the other air gap have different thicknesses.
